(19) United States
(12) Patent Application Publication
(10) Pub. No.: US 2012/0127318 A1
(43) Pub. Date: May 24, 2012

(54) SURVEILLANCE SYSTEM USING WIRELESS NETWORK, MASTER SENSOR NODE, AND SERVER APPARATUS

(75) Inventors: Yoo Seung SONG, Daejeon-si (KR); Sang Joon Park, Daejeon-si (KR); Youngwoo Choi, Daejeon-si (KR)

(73) Assignee: ELECTRONICS AND TELECOMMUNICATIONS RESEARCH INSTITUTE, Daejeon-si (KR)

(21) Appl. No.: 13/235,574

(22) Filed: Sep. 19, 2011

(30) Foreign Application Priority Data
Nov. 22, 2010 (KR) 10-2010-0116259

(51) Int. Cl. H04N 7/18

(52) U.S. Cl. 348/159; 348/E07.085

(57) ABSTRACT

A surveillance system includes a sensor node, a master sensor node and a server. The sensor node firstly determines whether an event occurs based on self-event information and supplementary event information received from the plurality of sensors. The master sensor node receives the occurrence of the event from the sensor node, and secondly determines whether the event occurred based on the self-event information and the supplementary event information. The server receives whether the event occurs from the master sensor node. The occurrence of the event can be autonomously detected and determined among the sensor node, the master sensor node, and the server.

### CROSS-REFERENCE TO RELATED APPLICATIONS

This application claims the benefit of priority of Korean Patent Application No. 10-2010-0116259 filed on Nov. 22, 2010, which is incorporated by reference in its entirety herein.

### BACKGROUND OF THE INVENTION

1. Field of the Invention

The present invention relates to a surveillance system and, more particularly, to a surveillance system using a wireless network, a master sensor node, and a server apparatus.

2. Related Art

In order to resolve problems such as measurements of traffic volume, signal violation vehicle enforcement, illegal parking vehicle enforcement, and social crime prevention, Closed-Circuit TeleVisions (CCTVs) have widely been deployed. Cases in which burglars or kidnappers are arrested using information about the burglars or kidnapper recorded on CCTV are recently increasing, and thus the installation of CCTV is spread.

However, there are cases where burglars or kidnappers are not arrested despite the installation of several CCTVs because there are blind spots in the surveillance of the CCTVs.

For example, in case of England, the number of CCTVs installed nationwide in order to prevent terror and crimes is 4.2 millions or more. Ten thousands or more CCTVs are operating in buildings, intersections, bus stops, railway stations, subway station, buses, railways, and the subways for 24 hours. It is almost impossible for persons to monitor a large quantity of information collected by the ten thousands or more CCTVs and to take measures.

In general, the number of CCTV screens that can be monitored by one person is limited. Furthermore, there is a limit to the sustainability time where a surveillance person can monitor CCTV screens without loosing concentration.

Accordingly, there is a need for a surveillance system capable of storing and processing a large quantity of information generated with an increase in the number of CCTVs, automatically recognizing and determining events, and informing an operator of the events.

### SUMMARY OF THE INVENTION

The present invention provides a surveillance system using a wireless network, a master sensor node, and a server apparatus.

In an aspect, a surveillance system using a wireless network includes a sensor node connected to a plurality of sensors and configured to firstly determine whether an event occurs based on self-event information and supplementary event information received from the plurality of sensors, a master sensor node connected to the sensor node through a wireless channel and configured to receive the occurrence of the event from the sensor node and secondly determine whether the event occurred based on the self-event information and the supplementary event information, and a server connected to the master sensor node and configured to receive whether the event occurs from the master sensor node.

The server may request video streams captured before the occurrence of the event from the sensor node and may review the event based on the video streams captured before the occurrence of the event.

The server may request the sensor node to send the video streams captured before the occurrence of the event via the master sensor node.

In another aspect, a master sensor node using a wireless network includes an interface unit configured to provide a wireless interface to a sensor node, and a processor connected to the interface unit, and configured to establish a first connection to the sensor node, establish a second connection to a server, receive whether an event occurs from the sensor node, wherein the sensor node determines based on self-event information acquired by the sensor node and supplementary event information acquired by a plurality of sensors, secondly determine whether the event occurs based on the self-event information and the supplementary event information, and notify the server of the occurrence of the secondly determined event.

In still another aspect, a server apparatus includes an interface unit configured to provide an interface to a master sensor node connected to a sensor node through a wireless channel, and a processor connected to the interface unit and configured to establish a connection to the master sensor node, receive an occurrence of an event from the master sensor node, wherein the sensor node firstly determines based on self-event information acquired by the sensor node and supplementary event information acquired by a plurality of sensors, the master sensor node secondly determines whether the event occurs based on the self-event information and the supplementary event information, and the master sensor node notifies the server of the occurrence of the secondly determined event, and review whether the event occurs.

### BRIEF DESCRIPTION OF THE DRAWINGS

FIG. 1 is a diagram showing the structure of a surveillance system according to an embodiment of the present invention.

FIG. 2 is a diagram showing an example in which cooperative communication between Sensor Nodes (SNs) is performed through one Master Sensor Node (MSN).

FIG. 3 is a diagram showing an example in which cooperative communication between SNs is performed through different MSNs.

FIG. 4 is a flowchart illustrating a procedure of operating the surveillance system according to an embodiment of the present invention.

FIG. 5 is a diagram illustrating a registration process.

FIG. 6 is a flowchart illustrating a proposed operation of the cooperative surveillance system.

FIG. 7 is a block diagram showing the surveillance system implementing an embodiment of the present invention.

### DESCRIPTION OF EXEMPLARY EMBODIMENTS

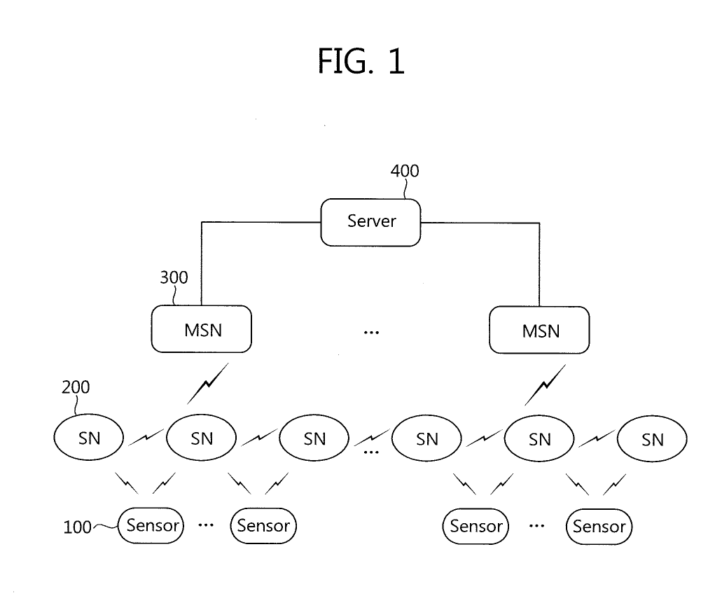

FIG. 1 is a diagram showing the structure of a surveillance system according to an embodiment of the present invention.

A sensor 100 sends event information about the object of an event to a Sensor Node (hereinafter referred to as an ‘SN’) 200 through a wireless channel. The wireless channel may be based on a short-range wireless communication standard, such as zigbee, bluetooth, and IEEE 802.11. The SN 200 may be connected to the sensor 100 through a wired channel.

The sensor 100 can sense a moving object and information about the direction and velocity of movement of the moving object and send the information to the SN 200 as event information.

The sensor 100 may include an underground sensor buried in a road or underground. The sensor 100 may include an object detection sensor, a temperature sensor, a humidity sensor, and an illumination sensor.

The SN 200 acquires an azimuth angle of an event- and video streams, and determines whether a event has been occurred based on those self event information and supplementary information received from the sensor 100. The SN 200 may be, for example, CCTV but has more intelligence in it.

A Master Sensor Node 300 (hereinafter referred to as an ‘MSN’) is connected to the SNs 200 through a wireless channel and configured to re-determine whether an event has occurred on the basis of information received from the SNs 200.

The MSN 300 may be connected to the SNs 200 via a mesh networkThe MSN 300 is connected to a server 400 or a control center over a wireless network or a wired network (for example, the Internet). The MSN 300 determinds an event as a result of secondly determination and informs the server 400 of the event. The server 400 makes a final decision for the occurred event based on the event information and video streams, received from the MSNs 300, and other statistical data generated for the event.

If the SN 200 firstly determines that an event has occurred, the SN 200 informs the MSN 300 of the occurrence of the event. The MSN 300 secondly determines whether the event has occurred on the basis of the data received from the SN 200 and informs the server 400 of the event

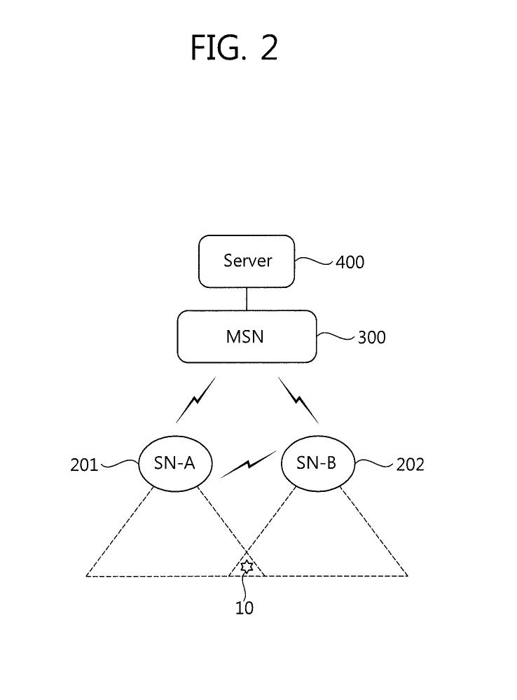

FIG. 2 is a diagram showing an example in which cooperative communication between SNs is performed through one MSN.

An SN-A 201 detects an event 10 and informs an MSN 300 of the event 10.

Assuming that the SN-B 202 also detects the event 10 and informs the MSN 300 of the occurrence of the event 10.

The MSN 300 requests both the SN-A 201 and the SN-B 202 to send information thereto, receives necessary data from the SN-A 201 and the SN-B 202, and secondly determines the event.

The MSN 300 reconfigures the event 10 through cooperative communication between the SNs and determines whether the event has occurred.

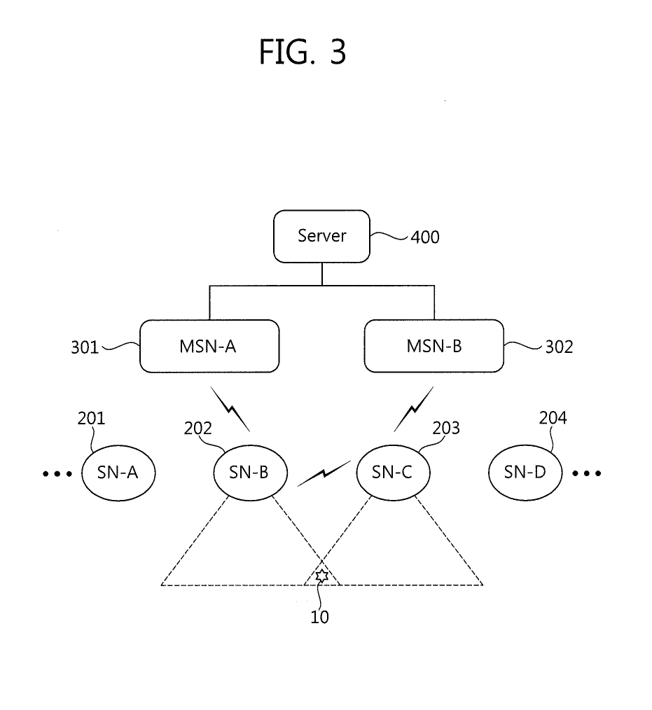

FIG. 3 is a diagram showing an example in which cooperative communication between SNs is performed through different MSNs.

An SN-B 202 detects an event 10 and informs an MSN-A 301 (i.e., an upper node connected thereto) of the event 10.

Assuming that the SN-C 203 also detects the event 10 and informs an MSN-B 302 (i.e., an upper node connected thereto) of the event 10.

The MSN-A 301 requests the SN-B 202 to send information thereto, receives necessary data from the SN-B 202, secondly determines the event, and informs a server 400 of the event. The MSN-B 302 requests the SN-C 203 to send information thereto, receives necessary data from the SN-C 203, secondly determines the event, and informs the server 400 of the event.

The server 400 requests video streams and other sense data from the SN-B 202 through the MSN-A 301 and also requests video streams and other sense data from the SN-C 203 through the MSN-B 302. The server 400 performs comprehensive analysis on the basis of cooperative communication the SNs.

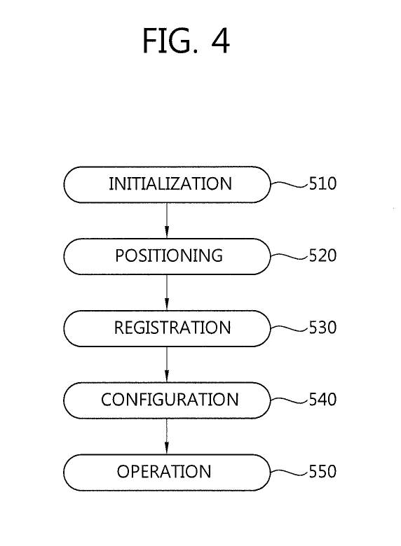

FIG. 4 is a flowchart illustrating a procedure of operating the surveillance system according to an embodiment of the present invention.

Each of SNs and MSNs are reset in order to check whether an internal function and operation is normal at step 510.

When a server issues a position detection command for the SNs, the position values of the SNs configuring a multi-hop wireless mesh network are sent to the server at step 520. The position information of the SN may be acquired by a Global Positioning System (GPS) mounted on the SN.

The SNs and the MSNs are registered with the server at step 530. The server configures several sensors and other devices connected to the registered SNs and MSNs, and configures a system characteristic to satisfy necessary service at step 540. Next, a cooperative surveillance system is normally operated at step 550.

The communication from the steps 530 to 550 may be performed in accordance with an Open Network Video Interface Forum (ONVIF) protocol which is widely used for the control and operation of intelligent sensors.

ONVIF is a forum for developing a standard for the interface of Internet Protocol (IP)-based security products. For further information of ONVIF, reference may be made to ‘http://www.onvif.org/’.

For the ONVIF protocol, reference may be made to “Open Network Video Interface Forum Core Specification Version 1.02” (hereinafter referred to as ‘ONVIF V1.02’) published June 2010.

In order to implement the proposed cooperative surveillance system, an additional ONVIF protocol is required. This is described in more detail below.

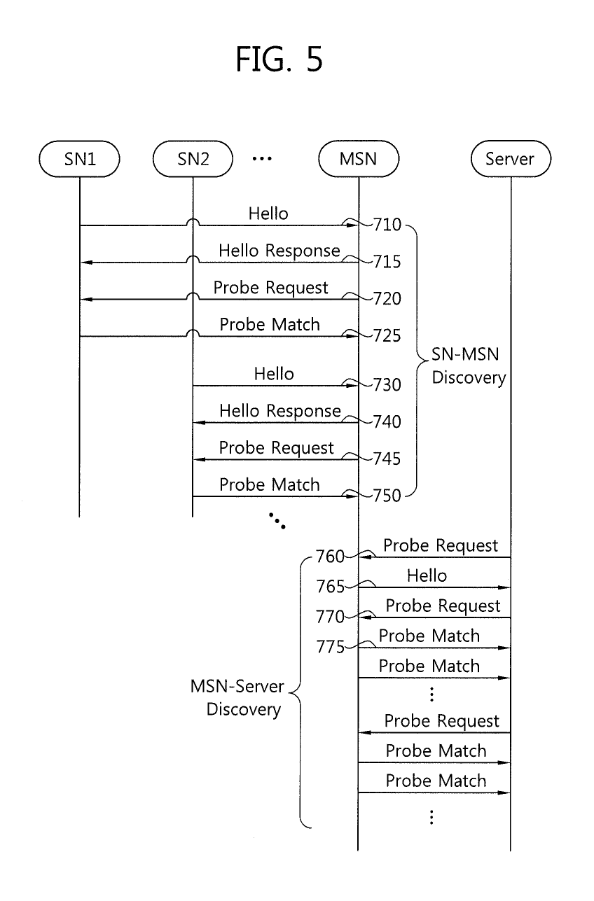

FIG. 5 is a diagram illustrating a registration process.

In the proposed cooperative surveillance system, an MSN performs a Discovery Proxy (DP) function. DP relays communication between the SN and the server through functions, such as port forward or IP mapping.

First, the MSN checks SNs dependent thereon by performing device discovery. Messages used in the device discovery include a hello message, a hello response message (i.e., a response to the hello message), a probe request message, and a probe match message (i.e., a response to the probe request message). For the messages, reference may be made to Paragraphs 7.4.2 and 7.4.3 of ONVIF V1.02.

The MSN establishes connection to an SN1. The SN1 sends a hello message to the MSN at step 710. The MSN sends a hello response message to the SN1 at step 715. Next, the MSN sends a probe request message to the SN1 at step 720. The SN1 sends a probe match message to the MSN at step 725.

Likewise, the MSN establishes connection to an SN2. The SN2 sends a hello message to the MSN at step 730. The MSN sends a hello response message to the SN2 at step 735. Next, the MSN sends a probe request message to the SN2 at step 740. The MSN sends a probe match message to the SN2 at step 745.

In this manner, device discovery between the MSN and the SN is performed.

Next, device discovery between a server and the MSN is performed, and connection between the server and the MSN is established. The MSN sends a hello message to the server at step 760. The server sends a hello response message to the MSN at step 765. Next, the server sends a probe request message to the MSN at step 770. The MSN sends a probe match message to the server at step 775.

In the device discovery process between the server and the MSN, information about SNs, managed by the MSN, may also be sent to the server.

The messages used in the device discovery process are described in the ONVIF V1.02 specification. However, the proposed invention is related to a method of performing the function of the MSN and the device discovery process between the SN and the MSN before the device discovery process between the SN and the server is performed. To this end, an additional protocol needs to be defined.

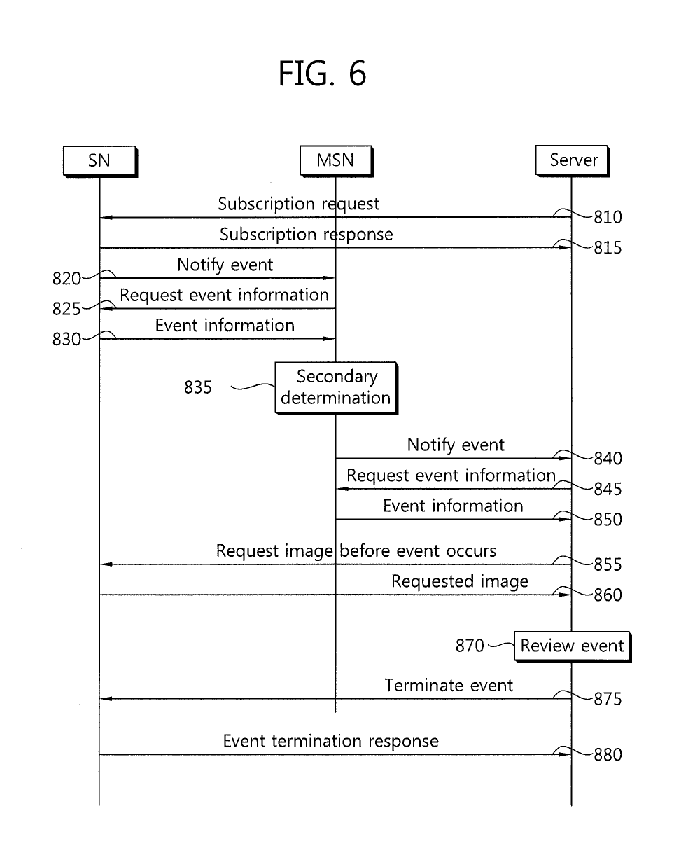

FIG. 6 is a flowchart illustrating a proposed operation of the cooperative surveillance system.

The server sends a subscription request message, informing that it is prepared to receive the generation of an event, to the SN through the MSN at step 810. In response to the subscription request message, the SN sends a subscription response message to the server through the MSN at step 815.

When a suspicious event occurs, the SN firstly determines whether the event has occurred and notified the MSN of the generation of the event at step 820.

The MSN requests event information necessary for determination about the informed event from the SN at step 825. The event information may include at least one of video streams, sensor information, environmental cognition parameter, and an event profile. The event information request may be sent through one message or may be sent for every information through a plurality of messages.

The MSN receives the event information from the SN at step 830.

The MSN secondly determines whether the event has occurred on the basis of the event information at step 835.

If, as a result of the secondly determination, the occurrence of the event is more sure, the MSN informs the server of the occurrence of the event at step 840.

The server requests the event information about the event to the MSN at step 845. In response to the request, the MSN sends the requested event information to the server at step 850.

The server may request video streams before the occurrence of the event from the SN through the MSN at step 855. The SN sends the video streams before the occurrence of the event to the server through the MSN at step 860.

The server reviews whether the event has occurred on the basis of the event information or the video streams before the occurrence of the event or both at step 870. The server makes a final determination, and proper actions according to the occurrence of the event can be taken.

The server sends an event termination message to the SN through the MSN at step 875. The SN sends an event termination response message to the server and then returns to a normal mode.

In order to operate the proposed surveillance system, an additional protocol needs to be defined in the existing ONVIF specification.

In the device discovery process, position information about each device and sensor information need to be provided. Accordingly, a category, such as the following table, needs to be added to the device capability of the ONVIF specification.

TABLE 1

| CATEGORY | CAPABILITY | CONTENTS |
|---|---|---|
| Position | XAddr | address for position service |
| Sensor | XAddr | address for sensor service |

In order to request the SN from sound sensor information, a GetSoundSensorInformationRequest message may be used. Accordingly, the following fields have to be added to a GetSoundSensorInformationResponse message which is a response to the sound sensor information request.

TABLE 2

| FIELD | CONTENTS |
|---|---|
| xs:integer Azimuth | orientation of sound sensor |
| xs:integer Elevation | height of sound sensor |
| xs:string Threshold | threshold of sound sensor |
| xs:string EventSoundValue | sound value when event occurs |

In order to request ground sensor information from the SN, a GetUppergroundSensorInformationRequest message may be used. Accordingly, the following fields have to be added to a GetUpperSensorInformationResponse message which is a response to the ground sensor information request.

TABLE 3

| FIELD | CONTENTS |
|---|---|
| xs:string Temperature | temperature |
| xs:string Illumination | illumination |
| xs:string GravityValue | gravity value |
| xs:string CompassValue | compass value |

In order to request underground sensor information from the SN, a GetUndergroundSensorInformationRequest message may be used. Accordingly, the following fields have to be added to a GetUndergroundSensorInformationResponse message which is a response to the underground sensor information request.

TABLE 4

| FIELD | CONTENTS |
|---|---|
| xs:string ObjectIDInfo | object identifier (ID) |
| xs:string ObjectVelocityInfo | speed of object |
| xs:string ObjectMovingDirection | direction of movement of |
| | object |

In order to request environmental cognition information from the SN, a GetEnvironmentalCognitionParameterRequest message may be used. Accordingly, the following fields have to be added to a GetEnvironmentalCognitionParameterResponse message which is a response to the environmental cognition information request.

TABLE 5

| FIELD | CONTENTS |
|---|---|
| xs:string Day | Time |
| xs:string DayorNight | day or night |
| xs:string RoadType | road type |
| xs:string RoadShape | road shape |
| xs:string RodeClass | road class |
| xs:string RoadWidth | road width |
| xs:string LocalInformation | Local information |
| xs:string EventFrequency | frequency of event |
| xs:string EventType | event type |
| xs:string TrafficStats | traffic condition |
| xs:string SpeedLimit | Speed limit |
| xs:string VehicleCount | number of vehicles |
| xs:string CameraHeight | camera height |
| xs:string CameraAngle | camera angle |
| xs:string ObjectVelocity | object velocity |

The following fields have to be added to a SetEnvironmentalCognitionParameterRequest message used to set environmental cognition information in the SN.

TABLE 6

| FIELD | CONTENTS |
|---|---|
| xs:string Day | time |
| xs:string DayorNight | day or night |
| xs:string RoadType | road type |
| xs:string RoadShape | road shape |
| xs:string RodeClass | road class |
| xs:string RoadWidth | road width |
| xs:string LocalInformation | local information |
| xs:string EventFrequency | frequency of event |
| xs:string EventType | event type |
| xs:string TrafficStats | traffic condition |
| xs:string SpeedLimit | speed limit |
| xs:string VehicleCount | number of vehicles |
| xs:string CameraHeight | camera height |
| xs:string CameraAngle | camera angle |
| xs:string ObjectVelocity | object velocity |

In order to request an event profile from the SN, a GetEventProfileRequest message may be used. Accordingly, the following fields have to be added to a GetEventProfileResponse message which is a response to the event profile request.

TABLE 7

| FIELD | CONTENTS |
|---|---|
| xs:Boolean EventOccurence | whether event has been generated |
| xs:string NumOfObject | number of objects |
| xs:string ROIcenterX | position of object |
| xs:string ROIcenterY | |
| xs:string ROIlefttopX | |
| xs:string ROIlefttopY | |
| xs:string ROIrightbottomX | |
| xs:string ROIrightbottomY | |
| xs:string EventProbability | event probability |
| xs:string EventID | event ID |

The server or the MSN may request an event termination from each SN. The following field has to be added to a GetEventTerminationRequest message used to request the event end.

TABLE 8

| FIELD | CONTENTS |
|---|---|
| xs:string eventID | event ID |

Furthermore, the following field has to be added to a GetEventTerminationResponse message which is a response to the event termination request.

TABLE 9

| FIELD | CONTENTS |
|---|---|
| xs:Boolean Terminate | whether an event has been terminated |

In order to request an image before the generation of an event from the SN, a GetXXsecPreviousEventInformationRequest message may be used. Accordingly, the following field has to be added to a GetXXsecPreviousEventInformationResponse message which is a response to the image request.

TABLE 10

| Field | Contents |
|---|---|
| Images | image information before an event is generated |

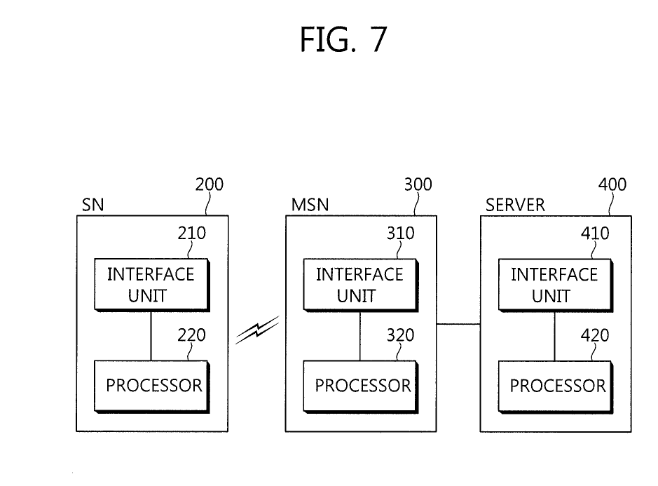

FIG. 7 is a block diagram showing the surveillance system implementing an embodiment of the present invention.

An SN 200 includes an interface unit 210 and a processor 220.

The interface unit 210 provides a wireless interface to a plurality of sensors (not shown) and an MSN 300.

In the above-described embodiments, the processor 220 implements the operation of the SN 200. The processor 220 firstly determine whether an event has occurred on the basis of pieces of supplementary event information, received from the plurality of sensors, and self-event information about the SN 200 and inform the MSN 300 of the generation of the event.

The MSN 300 includes an interface unit 310 and a processor 320.

The interface unit 210 provides a wireless interface to the SN 200 and provides a wired interface or a wireless interface to a server apparatus 400.

In the above-described embodiments, the processor 320 implements the operation of the MSN 300. The processor 320 may receive information about the generation of the event from the SN 200, secondly determine whether the event has occurred on the basis of the event information, and notify the server apparatus 400 of the occurrence of the event.

The server apparatus 400 includes an interface unit 410 and a processor 420.

Te interface unit 40 provides an interface to the MSN 300.

In the above-described embodiments, the processor 420 implements the operation of the server 400. The processor 420 may receive information about whether the event has occurred from the MSN 300 and review whether the event has been generated.

The occurrence of an event can be autonomously detected and determined between an SN, an MSN, and a server. Although a large number of sensors are installed, real-time monitoring is possible with a minimum manpower.

The processor may include application-specific integrated circuit (ASIC), other chipset, logic circuit and/or data processing device. The memory may include read-only memory (ROM), random access memory (RAM), flash memory, memory card, storage medium and/or other storage device. The RF unit may include baseband circuitry to process radio frequency signals. When the embodiments are implemented in software, the techniques described herein can be implemented with modules (e.g., procedures, functions, and so on) that perform the functions described herein. The modules can be stored in memory and executed by the processor. The memory can be implemented within the processor or external to the processor in which case those can be communicatively coupled to the processor via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A surveillance system using a wireless network, comprising:
a sensor node connected to a plurality of sensors and configured to firstly determine whether an event occurs based on self-event information and supplementary event information received from the plurality of sensors;
a master sensor node connected to the sensor node through a wireless channel and configured to:
receive the occurrence of the event from the sensor node, and
secondly determine whether the event occurred based on the self-event information and the supplementary event information; and
a server connected to the master sensor node and configured to receive whether the event occurs from the master sensor node.

2. The surveillance system of claim 1, wherein the server acquires video streams before the occurrence of the event from the sensor node and reviews whether the event occurs based on the video streams before the occurrence of the event.

3. The surveillance system of claim 2, wherein the server requests the sensor node to send the video streams before the occurrence of the event through the master sensor node.

4. The surveillance system of claim 1, wherein the supplementary event information includes at least one of sensor information, environmental cognition parameters, and an event profile acquired from the plurality of sensors.

5. The surveillance system of claim 4, wherein the sensor information includes at least one of ground sensor information and underground sensor information.

6. The surveillance system of claim 1, wherein a connection between the sensor node is established by:
requesting the connection from the sensor node to the master sensor node; and
responding to the request from the master sensor node to the sensor node.

7. The surveillance system of claim 1, wherein communication between the sensor node and the master sensor node and between the master sensor node and the server is performed in accordance with an Open Network Video Interface Forum (ONVIF) protocol.

8. The surveillance system of claim 1, wherein the sensor node is connected to at least one sensor node and configured to acquire self-event information from the at least one sensor node.

9. A master sensor node using a wireless network, comprising:
an interface unit configured to provide a wireless interface to a sensor node; and
a processor connected to the interface unit, and configured to:
establish a first connection to the sensor node,
establish a second connection to a server,
receive whether an event occurs from the sensor node, wherein the sensor node determines based on self-event information acquired by the sensor node and supplementary event information acquired by a plurality of sensors,
secondly determine whether the event occurs based on the self-event information and the supplementary event information, and
notify the server of the occurrence of the secondarily determined event.

10. The master sensor node of claim 9, wherein the event information includes at least one of sensor information, environmental cognition parameters, and an event profile received from the plurality of sensors.

11. The master sensor node of claim 9, wherein the processor is configured to establish the first connection by receiving a connection request from the sensor node and responding to the connection request.

12. The master sensor node of claim 9, wherein the processor is configured to establish the second connection by sending a connection request to the server and receiving a response to the connection request from the server.

13. A server apparatus, comprising:
an interface unit configured to provide an interface to a master sensor node connected to a sensor node through a wireless channel; and
a processor connected to the interface unit and configured to:
establish a connection to the master sensor node;
receive an occurrence of an event from the master sensor node, wherein the sensor node firstly determines based on self-event information acquired by the sensor node and supplementary event information acquired by a plurality of sensors, the master sensor node secondly determines whether the event occurs based on the self-event information and the supplementary event information, and the master sensor node notifies the server of the occurrence of the secondarily determined event; and
review whether the event occurs.

14. The server apparatus of claim 13, wherein the processor is configured to receive video streams before the occurrence of the event from the sensor node and review whether the event occurs based on the video streams before the occurrence of the event.

15. The server apparatus of claim 14, wherein the processor is configured to request the sensor node to send the video streams before the occurrence of the event through the master sensor node.
